(19) United States
(12) Patent Application Publication
(10) Pub. No.: US 2018/0320547 A1
(43) Pub. Date: Nov. 8, 2018

(54) ROTATABLE SHAFT WITH OIL MANAGEMENT FEATURE

(71) Applicant: ROLLS-ROYCE plc, London (GB)

(72) Inventors: Martin T. BENTLEY, Derby (GB); Stephen J. BENDALL, Derby (GB)

(73) Assignee: ROLLS-ROYCE plc, London (GB)

(21) Appl. No.: 15/969,895

(22) Filed: May 3, 2018

(30) Foreign Application Priority Data
May 5, 2017 (GB) 1707171.3

(51) Int. Cl. F01D 25/12; F16C 3/02

(52) U.S. Cl. CPC F01D 25/12; F16C 3/02; F16C 2360/23; F05D 2240/61; F05D 2220/32; F05D 2260/20

(57) ABSTRACT

A shaft (21) for use as a rotating shaft in a gas turbine engine has an axis (X), an outer surface, an inner surface (28), an upstream end and a downstream end. The shaft (21) is arranged, in use, to rotate in a circumferential direction (R) about the axis (X). The inner surface (28) includes a radially inwardly protruding flange (22), a circumferential array of radially extending apertures (26) provided in the flange (22) and an array of channels (24) extending from an upstream side to a downstream side of the flange (22). The channels arranged circumferentially between adjacent apertures (26) of the circumferential array of apertures (26).

### CROSS-REFERENCE TO RELATED APPLICATION

This application is based upon, and claims the benefit of priority from UK Patent Application No. 1707171.3, filed on 5 May 2017, the entire contents of which are hereby incorporated by reference.

### BACKGROUND

The present disclosure concerns shafts arranged, in use, to rotate and which are reliant on a supply of oil to lubricate the shaft during rotation. More particularly the disclosure concerns such shafts which include holes extending radially through the shaft wall and through which the oil is prone to escape.

A gas turbine engine comprises one or more turbines each of which is arranged to drive an associated compressor via a shaft. In some instances there is a requirement to provide apertures through the shaft from the outer surface of the shaft to the inner surface of the shaft in order to supply a fluid from the outer side of the shaft to the inner side of the shaft or visa-versa.

In order to provide the required flow area for the fluid it is known to provide two rows of apertures arranged in two planes arranged perpendicular to the axis of the shaft. However, in operation the shaft may be subjected to additional stresses due to the flow of the fluid, for example a coolant e.g. air, flowing through the apertures and the relatively high temperatures which may shorten the working life of the shaft. The fluid, coolant, may be arranged to cool turbine components and/or to pressurise chambers within the turbine of the gas turbine engine.

It has been recognised that, due to centrifugal forces arising during shaft rotation, oil on an inner wall of the shaft can migrate towards and escape from the apertures. The present disclosure seeks to provide an improved shaft design which facilitates better management of oil in the shaft.

### BRIEF SUMMARY

In accordance with the present disclosure there is provided a shaft having an axis, an outer surface, an inner surface, an upstream end and a downstream end, the shaft being arranged to rotate in a circumferential direction about the axis, the inner surface including a radially inwardly protruding flange, a circumferential array of apertures provided on the flange, the apertures extending from the inner surface to the outer surface and an array of channels extending from an upstream side to a downstream side of the flange, the channels arranged circumferentially between adjacent apertures of the circumferential array.

The flange may be integrally formed with axially adjacent portions of the inner surface of the shaft. The channels may extend in parallel with the axis. The channels may each have straight and parallel sides. Optionally the channels are shaped, for example, the channels are wider adjacent one or both ends and taper towards a narrower centre.

The radially inwardly protruding flange may be machined into the shaft during manufacture. Optionally, the radially inwardly protruding flange may comprise a separate component bonded to the inner surface of the shaft. For example, the flange may be brazed or welded to the inner surface of the shaft. In another option, the flange may be deposited onto the inner surface using an additive layer manufacturing method.

### BRIEF DESCRIPTION OF THE DRAWINGS

Embodiments of the present disclosure will now be further described by way of example with reference to the accompanying drawings in which;

FIG. 1 shows a shaft from Applicant's co-pending European patent application no. EP17158634.0;

FIG. 2 shows the inner surface of the shaft of FIG. 1;

FIG. 3 shows a first section through a shaft in accordance with the present disclosure;

FIG. 4 shows a second section taken through the flange of a shaft in accordance with the present disclosure and includes close up views of the section;

FIG. 5 is a sectional side view of a gas turbine engine.

### DETAILED DESCRIPTION

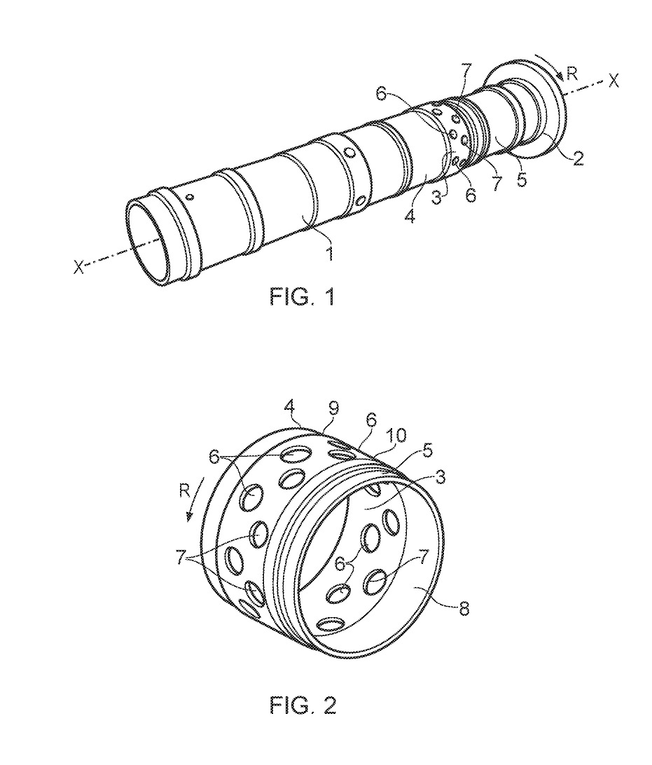

FIG. 1 shows an intermediate pressure turbine shaft of a gas turbine engine, for example a gas turbine engine having the configuration described in relation to FIG. 6. The shaft 1 has a downstream end 2 mounted for rotation in a direction R. The shaft includes a portion 3 which is thicker in a radial dimension than adjacent shaft portions 4 and 5. That is to say, the outer diameter of the shaft on portion 3 is greater than the outside diameter of the shaft on adjacent portions 4 and 5.

The thicker portion 3 includes a first circumferential array of apertures 6 and a second circumferential array of apertures 7. The second array of apertures 7 is spaced axially from the first array of apertures 6. The arrays 6, 7 are circumferentially displaced such that apertures of the second array 7 are positioned circumferentially between (but axially displaced from) apertures of the first array 6.

FIG. 2 shows an inner surface 8 of the shaft 1. As can be seen, the inner surface 8 has a consistent diameter across portion 3 and the adjacent portions 4 and 5 whereas the outer surface of thicker portion 3 has radially outwardly extending surfaces 9 and 10 with respect to the outer diameters of portions 4 and 5.

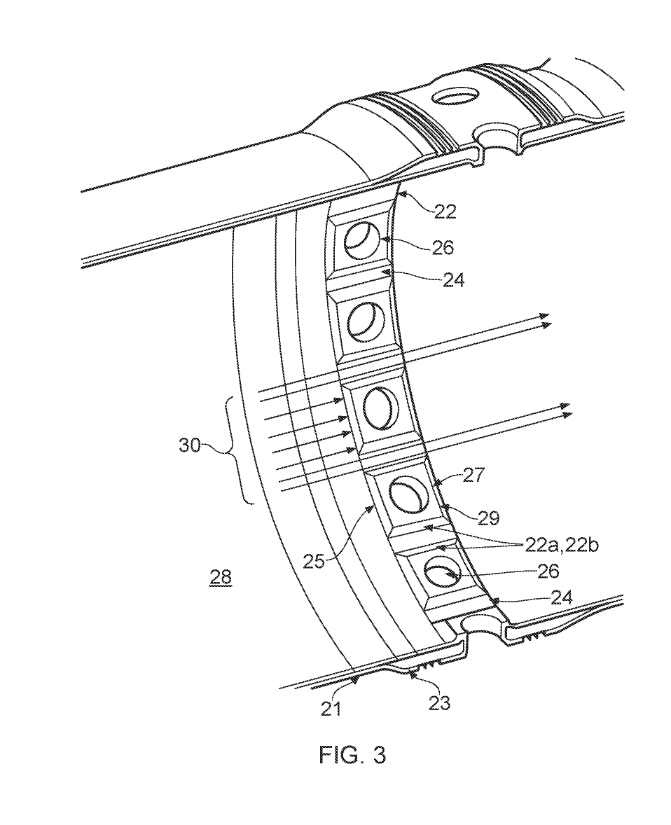

FIG. 3 shows a section through a shaft 21 in accordance with an embodiment of the present disclosure. In common with the shaft 1 of FIGS. 1 and 2, the shaft 21 includes a thickened portion 23 through which a circumferential array of substantially radially extending apertures 26 is provided. On an inner surface 28 of the shaft 21, radially aligned with the apertures 26, is a flanged portion 22. A circumferential array of axially extending channels 24 is provided in the flanged portion 22, a channel 24 arranged circumferentially between adjacent apertures 26. The maximum depth of the channels 24 may equate to the radial thickness of the flanged portion 22 such that the bottom of each channel is substantially flush with the inner surface 28 of the shaft 21. Axially extending sides 22a, 22b of the channels 24 may be tapered or radiused towards the bottom of the channel 24. Circumferentially extending sides 25, 27 of the channels 24 preferably extend substantially radially but may also be tapered or curved. It will be appreciated that the arrangement describes results in a raised platform 28 surrounding each aperture 26 on the inner surface 28 of the thickened portion 23.

In use, centrifugal forces in the rotating shaft 21 force oil (typically supplied to lubricate the shaft 21 and parts with which it interacts) against the inner surface 28. The oil is drawn axially along the inner surface 28 of the shaft 21. In other arrangements such as that shown in FIGS. 1 and 2 herein, some oil may escape through the apertures 6, 7 with the potential consequence of the shaft 1 and associated components becoming inadequately lubricated. In the presently described embodiment, the oil is diverted through the channels 24, avoiding the apertures 26. The grey arrows 30 in the figure represent the path taken by oil on inner surface 28. As can be seen the presence of the platform 29 surrounding each aperture 26 in combination with the centrifugal forces forcing the oil 30 radially against the inner surface 28 tends to guide the oil 30 into and through the channels 24.

Whilst the channels 26 are shown as substantially rectangular and the platforms 29 as substantially square, it will be appreciated this is not essential. For example, the channels 26 may be fluted at an upstream and downstream end resulting in more rounded platforms 29. Desirably, the channel and platform walls 22a, 22b, 25, 27 are shaped to provide minimum turbulence in the flow of the oil along the shaft 21 inner surface 28 whilst guiding the oil around the apertures 26.

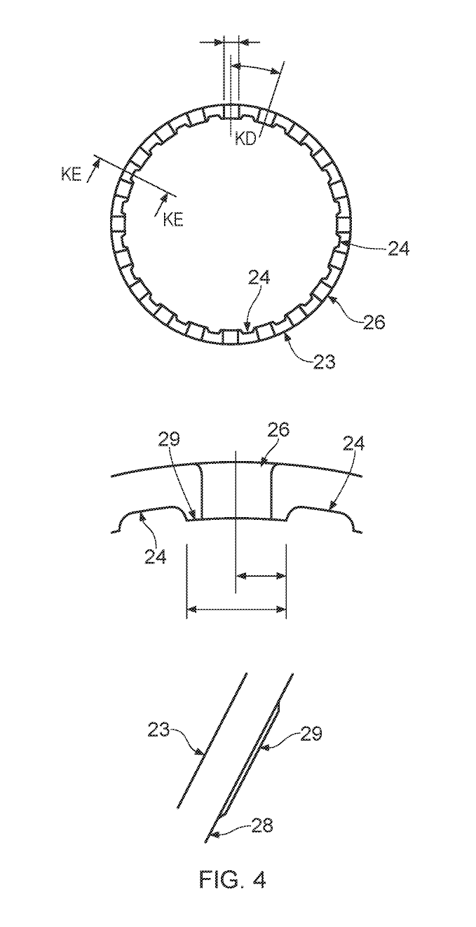

FIG. 4 shows a section through the thickened portion 23 and flange 22 accompanied by two more detailed views of this portion referenced KD and KE-KE. The more detailed views are scaled by a scale of 5:1.

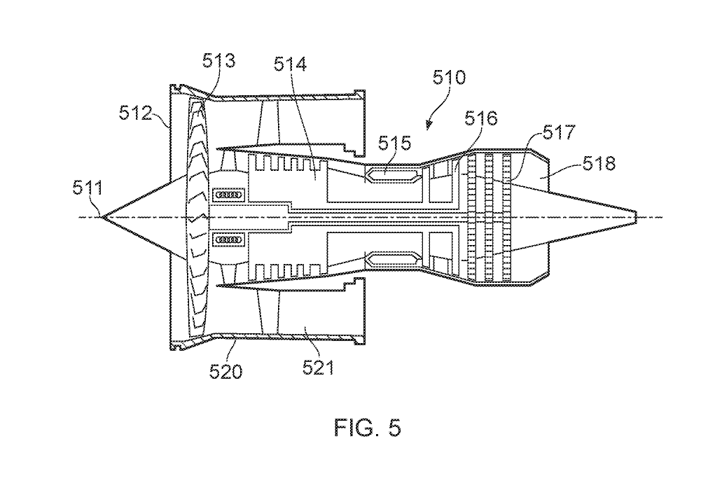

With reference to FIG. 5, a gas turbine engine is generally indicated at 510, having a principal and rotational axis 511. The engine 510 comprises, in axial flow series, an air intake 512, a propulsive fan 513, a high-pressure compressor 514, combustion equipment 515, a high-pressure turbine 516, a low-pressure turbine 517 and an exhaust nozzle 518. A nacelle 520 generally surrounds the engine 510 and defines the intake 512.

The gas turbine engine 510 works in the conventional manner so that air entering the intake 512 is accelerated by the fan 513 to produce two air flows: a first air flow into the high-pressure compressor 514 and a second air flow which passes through a bypass duct 521 to provide propulsive thrust. The high-pressure compressor 514 compresses the air flow directed into it before delivering that air to the combustion equipment 515.

In the combustion equipment 515 the air flow is mixed with fuel and the mixture combusted. The resultant hot combustion products then expand through, and thereby drive the high and low-pressure turbines 516, 517 before being exhausted through the nozzle 518 to provide additional propulsive thrust. The high 516 and low 517 pressure turbines drive respectively the high pressure compressor 514 and the fan 513, each by suitable interconnecting shaft.

Other gas turbine engines to which the present disclosure may be applied may have alternative configurations. By way of example such engines may have an alternative number of interconnecting shafts (e.g. three) and/or an alternative number of compressors and/or turbines. Further the engine may comprise a gearbox provided in the drive train from a turbine to a compressor and/or fan.

It will be understood that the invention is not limited to the embodiments above-described and various modifications and improvements can be made without departing from the concepts described herein and defined by the appended claims. Except where mutually exclusive, any of the features may be employed separately or in combination with any other features and the disclosure extends to and includes all combinations and sub-combinations of one or more features described herein.

1. A shaft having an axis, an outer surface, an inner surface, an upstream end and a downstream end, the shaft being arranged to rotate in a circumferential direction about the axis, the inner surface including a radially inwardly protruding flange, a circumferential array of radially extending apertures provided in the flange and an array of channels extending from an upstream side to a downstream side of the flange, the channels arranged circumferentially between adjacent apertures of the circumferential array of apertures.

2. The shaft as claimed in claim 1 wherein the flange is integrally formed with axially adjacent portions of the inner surface of the shaft.

3. The shaft as claimed in claim 1 wherein the channels extend in parallel with the axis.

4. The shaft as claimed in claim 1 wherein the channels each have straight and parallel sides.

5. The shaft as claimed in claim 1 wherein the channels are wider adjacent one or both ends and taper towards a narrower centre.

6. The shaft as claimed in claim 1 wherein the channels and flange together define a raised platform around each aperture extending radially from the inner surface of the shaft.

7. The shaft as claimed in claim 6 wherein the platform is round.

8. The shaft as claimed in claim 6 wherein the platform is square.

9. The shaft as claimed in claim 6 wherein one or more perimeter walls of the platform is inclined to the radial direction.

10. The shaft as claimed in claim 6 wherein one or more perimeter walls of the platform is curved.

11. The shaft as claimed in claim 1 arranged for rotation about the axis.

12. The shaft as claimed in claim 1 arranged for rotating turbines in a gas turbine.

13. A gas turbine engine comprising one or more shafts as defined in claim 1, the one or more shafts arranged for rotation during operation of the engine.
